(19) United States
(12) Patent Application Publication
(10) Pub. No.: US 2007/0124808 A1
(43) Pub. Date: May 31, 2007

(54) System and method for providing bi-directional communication service

(75) Inventors: Jeong-Woo Jwa, Jeju-city (KR); Choon-Sup Kim, Seongnam-si (KR); Beum Soo Kim, Seongnam-si (KR)

Correspondence Address: Richard P. Berg;Ladas & Parry, Suite 2100, 5670 Wilshire Boulevard, Los Angeles, CA, 90036, US

(73) Assignee: Geotel Corporation

(21) Appl. No.: 11/289,868

(22) Filed: Nov. 29, 2005

(51) Int. Cl. H04L 9/32

(52) U.S. Cl. 726/6

(57) ABSTRACT

A system for providing a bi-directional communication service is provided. The system includes a client terminal and a bi-directional communication service providing/managing server. The client terminal sends a short message after passing a user authentication and receives a short message from outside. The bi-directional communication service providing/managing server transmits the short message sent by the client terminal simultaneously to at least two other party client terminals after a user authentication process, or transmits a short message received from another party client terminal to the client terminal after a user authentication process.

### BACKGROUND OF THE INVENTION

(a) Field of the Invention

The present invention relates to a system for providing a bi-directional communication service and a method thereof. More particularly, the present invention relates to a system for providing a bi-directional communication service to client terminals including mobile phones and personal computers.

(b) Description of the Related Art

These days, various messenger services are provided through cable or wireless Internet networks. In such a messenger service, a user gets onto a server of a messenger service providing company through an Internet network using his own terminal, and then downloads a messenger program onto his terminal and installs the downloaded program. In addition, after running the messenger program and passing an authentication process, a user can send a short message to another terminal.

However, such a conventional messenger service has a drawback in that it is possible only when a client's terminal is a personal computer. In addition, the personal computer must pass a user authentication process in the messenger program in order to send a short message to another terminal.

Further, the other terminals receiving the sent short message are generally also an operating system such as a personal computer or similar type of device.

Still furthermore, since the conventional messenger service or the conventional short message service sends a message to only one selected client terminal, there is a limitation in providing an effective service to a user wishing to communicate with a plurality of terminals.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a system for providing a bi-directional communication service and a method thereof having advantages of transmitting a message to two or more client terminals at once.

An exemplary system for providing a bi-directional communication service according to an embodiment of the present invention includes: a client terminal sending a short message after passing a user authentication and receiving a short message from outside; and a bi-directional communication service providing/managing server for transmitting the short message sent by the client terminal simultaneously to at least two other party client terminals after a user authentication process, or transmitting a short message received from another party client terminal to the client terminal after a user authentication process.

The short message may include one of a multimedia message and pay contents related to sound and image.

The bi-directional communication service providing/managing server may store destination determining conditions therein and may transmit the received message to the determined destination, after determining a destination of the received message on the basis of destination determining information contained in the message received from the client terminal and the destination determining conditions.

In another embodiment of the present invention, a bi-directional communication service providing/managing server for bi-directionally transmitting messages between client terminals may stores destination determining conditions used for determining a destination where a received message is transmitted and transmits the received message to the determined destination, after determining a destination of the received message on the basis of destination determining information contained in the message received from the client terminal and the destination determining conditions.

In a bi-directional communication service providing method for transmitting a short message to a client terminal according to an embodiment of the present invention includes: performing user authentication using a password of a user input from outside; after the user authentication, checking whether the other party client terminal that will receive the short message sent by the client terminal is connected; and simultaneously transmitting the short message to at least two connected other party client terminals.

In another embodiment of the present invention, a bi-directional communication service providing method for bi-directionally transmitting a message between client terminals include: receiving a message containing destination determining information from a client terminal; determining a destination to which the received message is to be transmitted, on the basis of the destination determining information contained in the received message and predetermined destination determining conditions; and transmitting the received message to the determined destination.

The destination determining conditions may include a plurality of destination information corresponding to the destination determining information, and the received message may be transmitted to a plurality of client terminals corresponding to the plurality of destination information.

The destination determining information contained in the received message may include a mobile communication terminal number, and the received message may be transmitted to a mobile communication terminal corresponding to the mobile communication terminal number and at the same time to at least one other party client terminal.

### BRIEF DESCRIPTION OF THE DRAWINGS

FIG. 1 is a schematic diagram of a system for providing a bi-directional communication service according to an exemplary embodiment of the present invention.

FIG. 2 is a flowchart showing a method for providing a bi-directional communication service according to an exemplary embodiment of the present invention.

### DETAILED DESCRIPTION OF THE EMBODIMENTS

Exemplary embodiments of the present invention will hereinafter be described in detail with reference to the accompanying drawings.

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

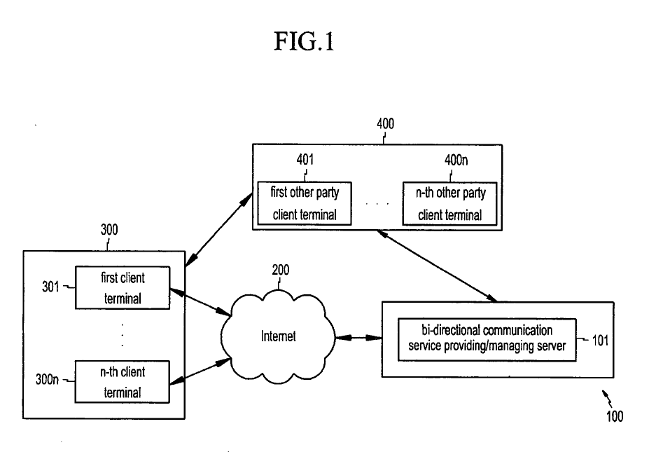

FIG. 1 is a schematic diagram of a system for providing a bi-directional communication service according to an exemplary embodiment of the present invention.

As shown in FIG. 1, a bi-directional communication service providing system 100 according to an exemplary embodiment of the present invention is connected to a plurality of client terminals, i.e., first to n-th client terminals 301 to 300n, via an Internet 200. The bi-directional communication service providing system 100 may include a bi-directional communication service providing/managing server 101.

The client terminal 300 may include a message program (for example, a messenger program) for performing transmitting and receiving short messages to and from another terminal, and clients may perform user authentication using the message program. Such user authentication can be used for charging and settling costs for transmitting/receiving messages.

The client terminal 300 may be any type of terminal such as a portable mobile communication terminal, a personal computer, and the like.

In addition, the client terminal 300 may transmit a short message (sometimes, a multimedia message and pay contents related to sound and image) to another party client terminal after the user authentication is completed.

A bi-directional communication service providing/managing server 101 performs a user authentication requested by the client terminal 300, and transmits a received short message to a target terminal (i.e., another party client terminal 400) after the user authentication is completed.

The other party client terminal 400 may include first to n-th other party client terminals 401 to 400n, and it may be any type of terminal such as a portable mobile communication terminal, a personal computer, and the like.

At this time, if a client terminal is connected thereto after being authenticated, the bi-directional communication service providing/managing server 101 transmits the short message to the client terminal and at the same time to other terminals, such as a mobile communication terminal, selected by a client.

For example, the bi-directional communication service providing/managing server 101 may store destination determining conditions therein. The bi-directional communication service providing/managing server 101 may determine a destination of the received message on the basis of destination determining information contained in the message received from the client terminal and the destination determining conditions, and then transmit the received message to the determined destination.

For example, the destination determining information may include a number of the other party client terminal to which a message will be transmitted, and the destination determining conditions may include a plurality of predetermined destination information corresponding to the terminal number. The message received from a client terminal may be transmitted to a plurality of terminals corresponding to the plurality of destination information.

That is, for example, the destination determining conditions may have a number of a client terminal and a preset messenger ID (identification) as destination information with respect to a specific number of a client terminal of the destination determining information included in the received message.

Therefore, when a message including destination determining information including a specific client terminal number is received, the bi-directional communication service providing/managing server 101 can transmit the received message to the other party client terminal corresponding to the specific client terminal number and to a preset messenger.

Further, the destination determining information included in the received message may include a mobile communication terminal number, and the received message can be transmitted to a mobile communication terminal corresponding to the mobile communication terminal number and simultaneously to at least one other party client terminal.

Therefore, although in the prior art there was an inconvenience in that in order to send a message to a client terminal except a mobile communication terminal an imaginary specific number allocated to the client terminal must be input, the system according to the exemplary embodiment of the present invention has a merit in that a message can be transmitted to a mobile communication terminal and simultaneously to other client terminals by sending a message by inputting only a mobile communication terminal number.

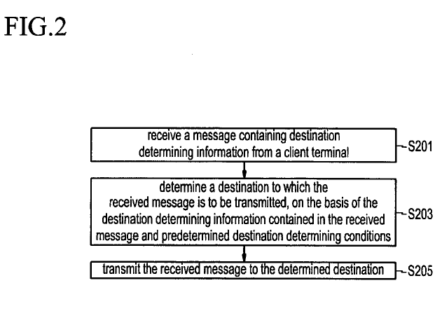

Hereinafter, referring to FIG. 2, a bi-directional communication service providing method for transmitting a short message to a client terminal according to an embodiment of the present invention will be explained. The bi-directional communication service providing method can be performed by the above-stated bi-directional communication service providing system according to the embodiments of the present invention.

The bi-directional communication service providing/managing server 101 receives a message containing destination determining information from a client terminal at step S201.

Then, at step S203, the bi-directional communication service providing/managing server 101 determines a destination to which the received message is to be transmitted, on the basis of the destination determining information contained in the received message and predetermined destination determining conditions.

The bi-directional communication service providing/managing server 101 transmits the received message to the determined destination at step S205.

The destination determining conditions may include a plurality of destination information corresponding to the destination determining information, and the received message may be transmitted to a plurality of client terminals corresponding to the plurality of destination information.

The destination determining information contained in the received message may include a mobile communication terminal number, and the received message may be transmitted to a mobile communication terminal corresponding to the mobile communication terminal number and at the same time to at least one other party client terminal.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

According to a system for providing a bi-directional communication service and a method thereof according to embodiments of the present invention, a client terminal can send a message to two or more other party client terminals simultaneously, so that a client may have great convenience and satisfaction in using a message service. This may cause an increase in a number of users.

What is claimed is:

1. A system for providing a bi-directional communication service comprising:
a client terminal sending a short message after passing a user authentication and receiving a short message from outside; and
a bi-directional communication service providing/managing server for transmitting the short message sent by the client terminal simultaneously to at least two other party client terminals after a user authentication process, or transmitting a short message received from another party client terminal to the client terminal after a user authentication process.

2. The system of claim 1, wherein the short message includes one of a multimedia message and pay contents related to sound and image.

3. The system of claim 1, wherein the bi-directional communication service providing/managing server stores destination determining conditions therein, after determining a destination of the received message on the basis of destination determining information contained in the message received from the client terminal and the destination determining conditions, and transmitting the received message to the determined destination.

4. The system of claim 3, wherein:
the destination determining conditions include a plurality of destination information corresponding to the destination determining information; and
the received message is transmitted to a plurality of client terminals corresponding to the plurality of destination information.

5. The system of claim 4, wherein:
the destination determining information contained in the received message includes a mobile communication terminal number; and
the received message is transmitted to a mobile communication terminal corresponding to the mobile communication terminal number and at the same time to at least one other party client terminal.

6. A bi-directional communication service providing/managing server for bi-directionally transmitting messages between client terminals,
storing destination determining conditions used for determining a destination where a received message is transmitted, and
after determining a destination of the received message on the basis of destination determining information contained in the message received from the client terminal and the destination determining conditions, transmitting the received message to the determined destination.

7. The bi-directional communication service providing/managing server of claim 6, wherein:
the destination determining conditions include a plurality of destination information corresponding to the destination determining information; and
the received message is transmitted to a plurality of client terminals corresponding to the plurality of destination information.

8. The bi-directional communication service providing/managing server of claim 7, wherein:
the destination determining information contained in the received message includes a mobile communication terminal number; and
the received message is transmitted to a mobile communication terminal corresponding to the mobile communication terminal number and at the same time to at least one other party client terminal.

9. A bi-directional communication service providing method for transmitting a short message to a client terminal, comprising:
performing user authentication using a password of a user input from outside;
after the user authentication, checking whether the other party client terminal that will receive the short message sent by the client terminal is connected; and
simultaneously transmitting the short message to at least two connected other party client terminals.

10. A bi-directional communication service providing method for bi-directionally transmitting a message between client terminals, comprising:
receiving a message containing destination determining information from a client terminal;
determining a destination to which the received message is to be transmitted, on the basis of the destination determining information contained in the received message and predetermined destination determining conditions; and
transmitting the received message to the determined destination.

11. The bi-directional communication service providing method of claim 10, wherein:
the destination determining conditions include a plurality of destination information corresponding to the destination determining information; and
the received message is transmitted to a plurality of client terminals corresponding to the plurality of destination information.

12. The bi-directional communication service providing method of claim 11, wherein:
the destination determining information contained in the received message includes a mobile communication terminal number; and
the received message is transmitted to a mobile communication terminal corresponding to the mobile communication terminal number and at the same time to at least one other party client terminal.
